(19) United States
(12) Patent Application Publication
(10) Pub. No.: US 2006/0128895 A1
(43) Pub. Date: Jun. 15, 2006

(54) Electriplast thermoset wet mix material and method of manufacture

(76) Inventor: Thomas Aisenbrey, Littleton, CO (US)

Correspondence Address: DOUGLAS R. SCHNABEL, 1531 WEDGEWOOD PLACE, ESSEXVILLE, MI, 48732, US

(21) Appl. No.: 11/335,363

(22) Filed: Jan. 19, 2006

Related U.S. Application Data
(63) Continuation-in-part of application No. 10/877,092, filed on Jun. 25, 2004.
Application No. 10/877,092 is a continuation of application No. 10/309,429, filed on Dec. 4, 2002, now Pat. No. 6,870,516.
Application No. 10/309,429 is a continuation-in-part of application No. 10/075,778, filed on Feb. 14, 2002, now Pat. No. 6,741,221.
(60) Provisional application No. 60/645,368, filed on Jan. 19, 2005.
(60) Provisional application No. 60/317,808, filed on Sep. 7, 2001.
(60) Provisional application No. 60/269,414, filed on Feb. 16, 2001.
(60) Provisional application No. 60/268,822, filed on Feb. 15, 2001.

(51) Int. Cl. C08G 73/02

(52) U.S. Cl. 525/185; 428/423.1

(57) ABSTRACT

A method to generate a thermoset wet mix material is achieved. The method comprises providing a thermosetting resin-based material. A bundle of micron conductive fiber strands is chopped. The chopped micron conductive fiber is added to the thermosetting resin-based material. The chopped fiber strands and thermosetting resin-based material are substantially homogeneously mixed to form a thermoset wet mix material. A method to form articles from such a thermoset wet mix material is also achieved.

### RELATED PATENT APPLICATIONS

This Patent Application claims priority to the U.S. Provisional Patent Application 60/645,368 filed on Jan. 19, 2005, which is herein incorporated by reference in its entirety.

This patent application is a Continuation-in-Part of INT01-002CIPC, filed as U.S. patent application Ser. No. 10/877,092, filed on Jun. 25, 2004, which is a Continuation of INT01-002CIP, filed as U.S. patent application Ser. No. 10/309,429, filed on Dec. 4, 2002, now issued as U.S. Pat. No. 6,870,516, also incorporated by reference in its entirety, which is a Continuation-in-Part application of docket number INT01-002, filed as U.S. patent application Ser. No. 10/075,778, filed on Feb. 14, 2002, now issued as U.S. Pat. No. 6,741,221, which claimed priority to U.S. Provisional Patent Applications Ser. No. 60/317,808, filed on Sep. 7, 2001, Ser. No. 60/269,414, filed on Feb. 16, 2001, and Ser. No. 60/268,822, filed on Feb. 15, 2001, all of which are incorporated by reference in their entirety.

### BACKGROUND OF THE INVENTION

(1) Field of the Invention

This invention relates to conductive polymers and, more particularly, to conductively doped resin-based materials for molding comprising micron conductive powders, micron conductive fibers, or a combination thereof, substantially homogenized within a base resin when molded. Even more particularly, this invention relates to a thermoset wet mix material and a method for forming such a thermoset wet mix material, wherein this material is useful for molding, coating, and spraying a conductive articles usable within the EMF electronic, acoustical, and thermal spectrums.

(2) Description of the Prior Art

Resin-based polymer materials are used for the manufacture of a wide array of articles. These polymer materials combine many outstanding characteristics, such as excellent strength to weight ratio, corrosion resistance, electrical isolation, and the like, with an ease of manufacture using a variety of well-established molding processes. Many resin-based polymer materials have been introduced into the market to provide useful combinations of characteristics.

Resin-based polymer materials are typically classified into two categories: thermoplastic and thermosetting. Thermoplastic materials are those that can be melted or, more precisely, heated to the material glass transition temperature, then formed into a desired shape, and then cooled to retain this shape. Thermoplastic materials can be re-heated and re-formed because the heating process merely creates a glass transition to make the material flowable. The heating process causes the material to exhibit plasticity but does not alter the basic bonding chemistry of the material. Finally, the thermoplastic material exhibits the same basic properties after molding as it did before molding.

By comparison, thermosetting materials are those that can only be formed a single time. Thermosetting materials are permanently set, or formed, by the molding or forming process. Thermoset materials typically are in a liquid state prior to the forming process. This liquid comprises a resin-based material that may be in monomer or polymer form. Other chemicals, such as plasticizers, solvents, emulsifiers, stabilizers, pigments, or the like may be present in the thermoset liquid. Heat, light, reactive chemicals, pressure, or the like, are then use to cause a chemical reaction wherein the monomer or polymer material forms a permanent set of bonds or linkages. This reaction is timed to occur in the molding die or other forming tool such that the material sets into a solid of the desired shape. After the setting reaction is completed, the thermosetting material exhibits substantially different properties than before the setting reaction. The process is not reversible.

Thermoset materials are particularly useful as spray coatings, foams, and the like, where it is advantage to have a flowable liquid during the application process. In these cases, the resin-based material and reactive chemical can be mixed in the material applicator such that the setting reaction occurs on the surface onto which the thermoset is applied. For example, a thermoset material may be sprayed onto a wooden manufactured article to provide an environmentally tough surface coating. The liquid state of the thermoset material allows the material to be conveniently applied by spraying yet the ‘set’ state of the material provides a hard, permanent coating.

In spite of many outstanding characteristics, resin-based polymer materials are unfortunately, typically poor conductors of thermal and electrical energy. Low thermal conductivity can be an advantageous in applications, such as cooking pan handles or electrical insulators. In other cases, however, resin-based materials known as insulators conduct thermal or electrical energy poorly and are not useful. Where high thermal or electrical conductivity is required, conductive metals, such as copper or aluminum or other metals, are typically used. A disadvantage of solid metal conductors is the density of these materials. For an example in electrical and thermal applications such as used in aircraft, satellites, vehicles, or even in hand held devices the weight due to solid metal conductors is significant. It is therefore desirable to replace solid metal conductors with less dense materials. Since resin-based materials are typically much less dense than metals, and can have the strength of metals, these materials would theoretically be good replacements for metals. However, the problems of low conductivity and doping must be resolved.

Attempts have been made in the art to create thermally and electrically conductive resin-based materials. There are two general classifications of such materials, intrinsically conductive and non-intrinsically conductive. Intrinsically conductive resin-based materials, which may also be referred to as conjugated resins, incorporate complex carbon molecule bonding within the polymer, increasing the conductivity of the material. Unfortunately, intrinsically conductive resin-based materials typically are difficult to manufacture, very expensive and are limited in conductivity. Non-intrinsically conductive resin-based materials, which also may be referred to as doped materials, are formed by mixing conductive fillers or dopants, such as conductive fibers, powders, or combinations thereof, within a base resin materials, resulting in increased conductivity in a molded form. Metallic and non-metallic fillers have been demonstrated in the art to provide substantially increased conductivity in a composite material while maintaining competitive cost.

Several prior art inventions relate to thermosetting materials. U.S. Pat. No. 5,968,419 to Sadhir et al teaches conductive polymer compositions, electrical devices and their methods of making. This invention utilizes a mixture of thermosetting resin, a liquid thermoset, and a conductive material to form conductive polymer compositions that have positive temperature coefficients. U.S. Patent Publication US 2002/0177027 A1 to Yeager et al teaches an electrically conductive thermoset composition and its method for preparation that utilizes a conductive agent from the list of graphite, conductive carbon black, conductive carbon fibers, metal fibers, metal particles, and particles of intrinsically conductive polymers that is useful for forming bipolar plates of fuel cells. U.S. Pat. No. 4,581,158 to Lin teaches a conductive thermoset-able dispersion composition useful as an ink, adhesive, gasket, or in EMI and RF shielding that utilizes conductive material in the form of particles, spheres, beads, powder, fibers, flakes or mixtures thereof from a list of copper, aluminum, iron, nickel and zinc. U.S. Patent Publication US 2004/0183702 A1 to Nachtigal et al teaches a magnetizable thermoplastic elastomer formed from a mixture of a thermoplastic polymer (such as a thermoplastic elastomer), a cured elastomeric polymeric material (such as a thermoset elastomer), and a magnetizable (ferrite) powder.

### SUMMARY OF THE INVENTION

A principle objective of the present invention is to provide an effective wet mix thermoset material useful for spraying and/or molding conductively doped resin-based articles.

A further object of the present invention is to provide a method to generate an effective wet mix thermoset material useful for spraying and/or molding conductively doped resin-based articles.

A further object of the present invention is to provide a method to form articles from a thermoset wet mix, conductively doped resin-based material.

In accordance with the objects of this invention, a method to generate a thermoset wet mix material is achieved. The method comprises providing a thermosetting resin-based material. A bundle of micron conductive fiber strands is chopped. The chopped micron conductive fiber is added to the thermosetting resin-based material. The chopped fiber strands and thermosetting resin-based material are substantially homogeneously mixed to form a thermoset wet mix material.

In accordance with the objects of this invention, a method to generate a thermoset wet mix material is achieved. The method comprises providing a thermosetting resin-based material. A chemically inert coupling agent is formed onto micron conductive fiber strands. The micron fiber strands are chopped. The chopped micron conductive fiber is added to the thermosetting resin-based material. The chopped fiber strands and the thermosetting resin-based material are substantially homogeneously mixed to form a thermoset wet mix material.

In accordance with the objects of this invention, a method to form an article is achieved. The method comprises providing a thermoset wet mix material comprising a thermosetting resin-based material substantially homogeneously mixed with micron chopped fiber. The thermoset wet mix material is placed into contact with a structure. The placed thermoset wet mix is set to complete the article.

### BRIEF DESCRIPTION OF THE DRAWINGS

In the accompanying drawings forming a material part of this description, there is shown:

FIG. 1 illustrates an embodiment of the present invention showing a method to manufacture a conductively doped resin-based wet mix thermoset material.

FIG. 2 illustrates an embodiment of a thermoset conductively doped resin-based material wherein the conductive materials comprise micron conductive fibers.

FIG. 3 illustrates an embodiment of a thermoset conductively doped resin-based material wherein the conductive materials comprise both conductive powder and micron conductive fibers.

FIGS. 4a and 4b illustrate an embodiment wherein conductive fabric-like materials are formed from the thermoset conductively doped resin-based material.

FIGS. 5a and 5b illustrate, in simplified schematic form, an injection molding apparatus and an extrusion molding apparatus that may be used to mold articles of a conductively doped resin-based material.

FIG. 6 illustrates an embodiment of a method to form a conductively doped resin-based material of the present invention.

### DESCRIPTION OF THE PREFERRED EMBODIMENTS

The present invention relates to conductively doped resin-based materials comprising micron conductive powders, micron conductive fibers, or a combination thereof, substantially homogenized within a base resin. More particularly, the present invention relates to thermoset wet mix materials comprising a conductive loading material and a resin-based material that are useful in the manufacture of articles of conductively doped resin-based materials.

The conductively doped resin-based materials of the invention are base resins doped, with conductive materials, which then transforms any base resin into a conductor rather than an insulator. The resins provide the structural integrity to the molded part. The micron conductive fibers, micron conductive powders, or a combination thereof, are substantially homogenized within the base resin during the wet mix manufacturing process and/or subsequent molding or spraying processes, providing electrical, thermal, and acoustical continuity. The resulting molded article comprises a three dimensional, continuous network of conductive loading and polymer matrix. Because the wet mix material is in a liquid form, the material can be applied to other articles via spraying, dipping, coating, painting, or the like

The conductively doped resin-based materials can be molded, extruded or the like to provide almost any desired shape or size. The molded conductively doped resin-based materials can also be cut, stamped, or vacuumed formed from an injection molded or extruded sheet or bar stock, over-molded, laminated, milled, or the like, to provide the desired shape and size. The thermal, electrical, and acoustical continuity and or conductivity characteristics of articles or parts fabricated using conductively doped resin-based materials depends on the composition of the conductively doped resin-based materials, of which the doping parameters and or materials can be adjusted, to aid in achieving the desired structural, electrical or other physical characteristics of the then molded material. The selected materials used to fabricate the articles are substantially homogenized together using molding techniques and or methods such as injection molding, over-molding, insert molding, compression molding, thermo-set, protrusion, extrusion, calendaring, or the like. Characteristics related to 2D, 3D, 4D, and 5D designs, molding and electrical characteristics, include the physical and electrical advantages that can be achieved during the molding process of the actual parts and the molecular polymer physics associated within the conductive networks within the molded part(s) or formed material(s).

In the conductively doped resin-based material, electrons travel from point to point, following the path of least resistance. Most resin-based materials are insulators and represent a high resistance to electron passage. The doping within the resin-based material alters the inherent resistance of the polymers. At a threshold concentration of conductively doping, the resistance through the combined mass is lowered enough to allow electrons movement. Speed of electron movement depends on conductive doping concentration and the materials chemical make up, that is, the separation between the conductive doping particles. Increasing conductive doping content reduces interparticle separation distance, and, at a critical distance known as the percolation point, resistance decreases dramatically and free electrons move rapidly.

Resistivity is a material property that depends on the atomic bonding of the microstructure of the material. The atomic microstructure material properties within the conductively doped resin-based material are altered when molded into a structure. A substantially homogenized conductive microstructure of delocalized valance electrons is created within the valance and conduction bands of the said molecules. This microstructure provides sufficient charge carriers within the molded matrix structure. As a result, a low density, low resistivity, lightweight, durable, resin based polymer microstructure material is achieved. This material can exhibit conductivity comparable to that of highly conductive metals such as silver, copper or aluminum, while maintaining the superior structural characteristics found in many plastics and rubbers or other structural resin based materials.

The use of conductively doped resin-based materials in the fabrication of articles and parts significantly lowers the cost of materials and the design and manufacturing processes used to hold ease of close tolerances, by forming these materials into desired shapes and sizes. The articles can be manufactured into infinite shapes and sizes using conventional forming and molding methods such as injection molding, over-molding, compression molding, thermoset molding, or extrusion, calendaring, or the like. The conductively doped resin-based materials, when molded, typically but not exclusively produce a desirable usable range of resistivity of less than about 5 to more than about 25 ohms per square, but other resistivities can be achieved by varying the dopants, doping parameters, and/or base resin selection(s).

The conductively doped resin-based materials comprise micron conductive powders, micron conductive fibers, or any combination thereof, which are substantially homogenized together within the base resin, during the molding process, yielding an easy to produce low cost, electrical, thermal, and acoustical performing, close tolerance manufactured part or circuit. The resulting molded article comprises a three dimensional, continuous capillary network of conductive doping particles contained and or bonding within the polymer matrix. Exemplary micron conductive powders include carbons, graphites, amines, eeonomers, or the like, and/or of metal powders such as nickel, copper, silver, aluminum, nichrome, or plated or the like. The use of carbons or other forms of powders such as graphite(s) etc. can create additional low level electron exchange and, when used in combination with micron conductive fibers, creates a micron filler element within the micron conductive network of fiber(s) producing further electrical conductivity as well as acting as a lubricant for the molding equipment. Carbon nano-tubes may be added to the conductively doped resin-based material. The addition of conductive powder to the micron conductive fiber doping may improve the electrical continuity on the surface of the molded part to offset any skinning effect that occurs during molding.

The micron conductive fibers may be metal fiber or metal plated fiber. Further, the metal plated fiber may be formed by plating metal onto a metal fiber or by plating metal onto a non-metal fiber. Exemplary metal fibers include, but are not limited to, stainless steel fiber, copper fiber, nickel fiber, silver fiber, aluminum fiber, nichrome fiber, or the like, or combinations thereof. Exemplary metal plating materials include, but are not limited to, copper, nickel, cobalt, silver, gold, palladium, platinum, ruthenium, rhodium, and nichrome, and alloys of thereof. Any platable fiber may be used as the core for a non-metal fiber. Exemplary non-metal fibers include, but are not limited to, carbon, graphite, polyester, basalt, melamine, man-made and naturally-occurring materials, and the like. In addition, superconductor metals, such as titanium, nickel, niobium, and zirconium, and alloys of titanium, nickel, niobium, and zirconium may also be used as micron conductive fibers and/or as metal plating onto fibers in the present invention.

Where micron fiber is combined with base resin, the micron fiber may be pretreated to improve performance. According to one embodiment of the present invention, conductive or non-conductive powders are leached into the fibers prior to extrusion. In other embodiments, the fibers are subjected to any or several chemical modifications in order to improve the fibers interfacial properties. Fiber modification processes include, but are not limited to: chemically inert coupling agents; gas plasma treatment; anodizing; mercerization; peroxide treatment; benzoylation; or other chemical or polymer treatments.

Chemically inert coupling agents are materials that are molecularly bonded onto the surface of metal and or other fibers to provide surface coupling, mechanical interlocking, inter-difussion and adsorption and surface reaction for later bonding and wetting within the resin-based material. This chemically inert coupling agent does not react with the resin-based material. An exemplary chemically inert coupling agent is silane. In a silane treatment, silicon-based molecules from the silane bond to the surface of metal fibers to form a silicon layer. The silicon layer bonds well with resin-based material yet does not react with the resin-based material. As an additional feature during a silane treatment, oxane bonds with any water molecules on the fiber surface to thereby eliminate water from the fiber strands. Silane, amino, and silane-amino are three exemplary pre-extrusion treatments for forming chemically inert coupling agents on the fiber.

In a gas plasma treatment, the surfaces of the metal fibers are etched at atomic depths to re-engineer the surface. Cold temperature gas plasma sources, such as oxygen and ammonia, are useful for performing a surface etch prior to extrusion. In one embodiment of the present invention, gas plasma treatment is first performed to etch the surfaces of the fiber strands. A silane bath coating is then performed to form a chemically inert silicon-based film onto the fiber strands. In another embodiment, metal fiber is anodized to form a metal oxide over the fiber. The fiber modification processes described herein are useful for improving interfacial adhesion, improving wetting during homogenization, and/or reducing oxide growth (when compared to non-treated fiber). Pretreatment fiber modification also reduces levels of particle dust, fines, and fiber release during subsequent cutting of the molded conductively doped resin-based material.

The resin-based structural material may be any polymer resin or combination of compatible polymer resins. Non-conductive resins or inherently conductive resins may be used as the structural material. Conjugated polymer resins, complex polymer resins, and/or inherently conductive resins may be used as the structural material. The dielectric properties of the resin-based material will have a direct effect upon the final electrical performance of the conductively doped resin-based material. Many different dielectric properties are possible depending on the chemical makeup and/or arrangement, such as linking, cross-linking or the like, of the polymer, co-polymer, monomer, ter-polymer, or homo-polymer material. Structural material can be, here given as examples and not as an exhaustive list, polymer resins produced by GE PLASTICS, Pittsfield, Mass., a range of other plastics produced by GE PLASTICS, Pittsfield, Mass., a range of other plastics produced by other manufacturers, silicones produced by GE SILICONES, Waterford, N.Y., or other flexible resin-based rubber compounds produced by other manufacturers.

The resin-based structural material doped with micron conductive powders, micron conductive fibers, or in combination thereof can be molded, using conventional molding methods such as injection molding or over-molding, or extrusion to create desired shapes and sizes. The molded conductively doped resin-based materials can also be stamped, cut or milled as desired to form create the desired shapes and form factor(s). The doping composition and directionality associated with the micron conductors within the doped base resins can affect the electrical and structural characteristics of the articles and can be precisely controlled by mold designs, gating and or protrusion design(s) and or during the molding process itself. In addition, the resin base can be selected to obtain the desired thermal characteristics such as very high melting point or specific thermal conductivity.

A resin-based sandwich laminate could also be fabricated with random or continuous webbed micron stainless steel fibers or other conductive fibers, forming a cloth like material. The webbed conductive fiber can be laminated or the like to materials such as Teflon, Polyesters, or any resin-based flexible or solid material(s), which when discretely designed in fiber content(s), orientation(s) and shape(s), will produce a very highly conductive flexible cloth-like material. Such a cloth-like material could also be used in forming articles that could be embedded in a person's clothing as well as other resin materials such as rubber(s) or plastic(s). When using conductive fibers as a webbed conductor as part of a laminate or cloth-like material, the fibers may have diameters of between about 3 and 12 microns, typically between about 8 and 12 microns or in the range of about 10 microns, with length(s) that can be seamless or overlapping.

The conductively doped resin-based material may also be formed into a prepreg laminate, cloth, or webbing. A laminate, cloth, or webbing of the conductively doped resin-based material is first homogenized with a resin-based material. In various embodiments, the conductively doped resin-based material is dipped, coated, sprayed, and/or extruded with resin-based material to cause the laminate, cloth, or webbing to adhere together in a prepreg grouping that is easy to handle. This prepreg is placed, or laid up, onto a form and is then heated to form a permanent bond. In another embodiment, the prepreg is laid up onto the impregnating resin while the resin is still wet and is then cured by heating or other means. In another embodiment, the wet lay-up is performed by laminating the conductively doped resin-based prepreg over a honeycomb structure. In another embodiment, the honeycomb structure is made from conductively doped, resin-based material. In yet another embodiment, a wet prepreg is formed by spraying, dipping, or coating the conductively doped resin-based material laminate, cloth, or webbing in high temperature capable paint.

Prior art carbon fiber and resin-based composites are found to display unpredictable points of failure. In carbon fiber systems there is little if any elongation of the structure. By comparison, in the present invention, the conductively doped resin-based material, even if formed with carbon fiber or metal plated carbon fiber, displays greater strength of the mechanical structure due to the substantial homogenization of the fiber in the thermoset wet mix. As a result a structure formed of the conductively doped resin-based material of the present invention will maintain structurally even if crushed while a comparable carbon fiber composite will break into pieces.

The conductively doped resin-based material of the present invention can be made resistant to corrosion and/or metal electrolysis by selecting micron conductive fiber and/or micron conductive powder dopants and base resins that are resistant to corrosion and/or metal electrolysis. For example, if a corrosion/electrolysis resistant base resin is combined with fibers/powders or in combination of such as stainless steel fiber, inert chemical treated coupling agent warding against corrosive fibers such as copper, silver and gold and or carbon fibers/powders, then corrosion and/or metal electrolysis resistant conductively doped resin-based material is achieved. Another additional and important feature of the present invention is that the conductively doped resin-based material of the present invention may be made flame retardant. Selection of a flame-retardant (FR) base resin material allows the resulting product to exhibit flame retardant capability. This is especially important in applications as described herein.

The substantially homogeneous mixing of micron conductive fiber and/or micron conductive powder and base resin described in the present invention may also be described as doping. That is, the substantially homogeneous mixing transforms a typically non-conductive base resin material into a conductive material. This process is analogous to the doping process whereby a semiconductor material, such as silicon, can be converted into a conductive material through the introduction of donor/acceptor ions as is well known in the art of semiconductor devices. Therefore, the present invention uses the term doping to mean converting a typically non-conductive base resin material into a conductive material through the substantially homogeneous mixing of micron conductive fiber and/or micron conductive powder within a base resin.

As an additional and important feature of the present invention, the molded conductor doped resin-based material exhibits excellent thermal dissipation characteristics. Therefore, articles manufactured from the molded conductor doped resin-based material can provide added thermal dissipation capabilities to the application. For example, heat can be dissipated from electrical devices physically and/or electrically connected to an article of the present invention.

As a significant advantage of the present invention, articles constructed of the conductively doped resin-based material can be easily interfaced to an electrical circuit or grounded. In one embodiment, a wire can be attached to conductively doped resin-based articles via a screw that is fastened to the article. For example, a simple sheet-metal type, self tapping screw can, when fastened to the material, can achieve excellent electrical connectivity via the conductive matrix of the conductively doped resin-based material. To facilitate this approach a boss may be molded as part of the conductively doped resin-based material to accommodate such a screw. Alternatively, if a solderable screw material, such as copper, is used, then a wire can be soldered to the screw is embedded into the conductively doped resin-based material. In another embodiment, the conductively doped resin-based material is partly or completely plated with a metal layer. The metal layer forms excellent electrical conductivity with the conductive matrix. A connection of this metal layer to another circuit or to ground is then made. For example, if the metal layer is solderable, then a soldered connection may be made between the article and a grounding wire.

Where a metal layer is formed over the surface of the conductively doped resin-based material, any of several techniques may be used to form this metal layer. This metal layer may be used for visual enhancement of the molded conductively doped resin-based material article or to otherwise alter performance properties. Well-known techniques, such as electroless metal plating, electro plating, electrolytic metal plating, sputtering, metal vapor deposition, metallic painting, or the like, may be applied to the formation of this metal layer. If metal plating is used, then the resin-based structural material of the conductively doped, resin-based material is one that can be metal plated. There are many of the polymer resins that can be plated with metal layers. For example, GE Plastics, SUPEC, VALOX, ULTEM, CYCOLAC, UGIKRAL, STYRON, CYCOLOY are a few resin-based materials that can be metal plated. Electroless plating is typically a multiple-stage chemical process where, for example, a thin copper layer is first deposited to form a conductive layer. This conductive layer is then used as an electrode for the subsequent plating of a thicker metal layer.

A typical metal deposition process for forming a metal layer onto the conductively doped resin-based material is vacuum metallization. Vacuum metallization is the process where a metal layer, such as aluminum, is deposited on the conductively doped resin-based material inside a vacuum chamber. In a metallic painting process, metal particles, such as silver, copper, or nickel, or the like, are dispersed in an acrylic, vinyl, epoxy, or urethane binder. Most resin-based materials accept and hold paint well, and automatic spraying systems apply coating with consistency. In addition, the excellent conductivity of the conductively doped resin-based material of the present invention facilitates the use of extremely efficient, electrostatic painting techniques.

The conductively doped resin-based materials can be contacted in any of several ways. In one embodiment, a pin is embedded into the conductively doped resin-based material by insert molding, ultrasonic welding, pressing, or other means. A connection with a metal wire can easily be made to this pin and results in excellent contact to the conductively doped resin-based material conductive matrix. In another embodiment, a hole is formed in to the conductively doped resin-based material either during the molding process or by a subsequent process step such as drilling, punching, or the like. A pin is then placed into the hole and is then ultrasonically welded to form a permanent mechanical and electrical contact. In yet another embodiment, a pin or a wire is soldered to the conductively doped resin-based material. In this case, a hole is formed in the conductively doped resin-based material either during the molding operation or by drilling, stamping, punching, or the like. A solderable layer is then formed in the hole. The solderable layer is preferably formed by metal plating. A conductor is placed into the hole and then mechanically and electrically bonded by point, wave, or reflow soldered.

Another method to provide connectivity to the conductively doped resin-based material is through the application of a solderable ink film to the surface. One exemplary solderable ink is a combination of copper and solder particles in an epoxy resin binder. The resulting mixture is an active, screen-printable and dispensable material. During curing, the solder reflows to coat and to connect the copper particles and to thereby form a cured surface that is directly solderable without the need for additional plating or other processing steps. Any solderable material may then be mechanically and/or electrically attached, via soldering, to the conductively doped resin-based material at the location of the applied solderable ink. Many other types of solderable inks can be used to provide this solderable surface onto the conductively doped resin-based material of the present invention. Another exemplary embodiment of a solderable ink is a mixture of one or more metal powder systems with a reactive organic medium. This type of ink material is converted to solderable pure metal during a low temperature cure without any organic binders or alloying elements.

A ferromagnetic conductively doped resin-based material may be formed of the present invention to create a magnetic or magnetizable form of the material. Ferromagnetic micron conductive fibers and/or ferromagnetic conductive powders are substantially homogenized with the base resin. Ferrite materials and/or rare earth magnetic materials are added as a conductive doping to the base resin. With the substantially homogeneous mixing of the ferromagnetic micron conductive fibers and/or micron conductive powders, the ferromagnetic conductively doped resin-based material is able to produce an excellent low cost, low weight, high aspect ratio magnetize-able item. The magnets and magnetic devices of the present invention can be magnetized during or after the molding process. Adjusting the doping levels and or dopants of ferromagnetic micron conductive fibers and/or ferromagnetic micron conductive powders that are homogenized within the base resin can control the magnetic strength of the magnets and magnetic devices. By increasing the aspect ratio of the ferromagnetic doping, the strength of the magnet or magnetic devices can be substantially increased. The substantially homogenous mixing of the conductive fibers/powders or in combinations there of allows for a substantial amount of dopants to be added to the base resin without causing the structural integrity of the item to decline mechanically. The ferromagnetic conductively doped resin-based magnets display outstanding physical properties of the base resin, including flexibility, moldability, strength, and resistance to environmental corrosion, along with superior magnetic ability. In addition, the unique ferromagnetic conductively doped resin-based material facilitates formation of items that exhibit superior thermal and electrical conductivity as well as magnetism.

A high aspect ratio magnet is easily achieved through the use of ferromagnetic conductive micron fiber or through the combination of ferromagnetic micron powder with conductive micron fiber. The use of micron conductive fiber allows for molding articles with a high aspect ratio of conductive fibers/powders or combinations there of in a cross sectional area. If a ferromagnetic micron fiber is used, then this high aspect ratio translates into a high quality magnetic article. Alternatively, if a ferromagnetic micron powder is combined with micron conductive fiber, then the magnetic effect of the powder is effectively spread throughout the molded article via the network of conductive fiber such that an effective high aspect ratio molded magnetic article is achieved. The ferromagnetic conductively doped resin-based material may be magnetized, after molding, by exposing the molded article to a strong magnetic field. Alternatively, a strong magnetic field may be used to magnetize the ferromagnetic conductively doped resin-based material during the molding process.

The ferromagnetic conductively doped is in the form of fiber, powder, or a combination of fiber and powder. The micron conductive powder may be metal fiber or metal plated fiber or powders. If metal plated fiber is used, then the core fiber is a platable material and may be metal or non-metal. Exemplary ferromagnetic conductive fiber materials include ferrite, or ceramic, materials as nickel zinc, manganese zinc, and combinations of iron, boron, and strontium, and the like. In addition, rare earth elements, such as neodymium and samarium, typified by neodymium-iron-boron, samarium-cobalt, and the like, are useful ferromagnetic conductive fiber materials. Exemplary ferromagnetic micron powder leached onto the conductive fibers include ferrite, or ceramic, materials as nickel zinc, manganese zinc, and combinations of iron, boron, and strontium, and the like. In addition, rare earth elements, such as neodymium and samarium, typified by neodymium-iron-boron, samarium-cobalt, and the like, are useful ferromagnetic conductive powder materials. A ferromagnetic conductive doping may be combined with a non-ferromagnetic conductive doping to form a conductively doped resin-based material that combines excellent conductive qualities with magnetic capabilities.

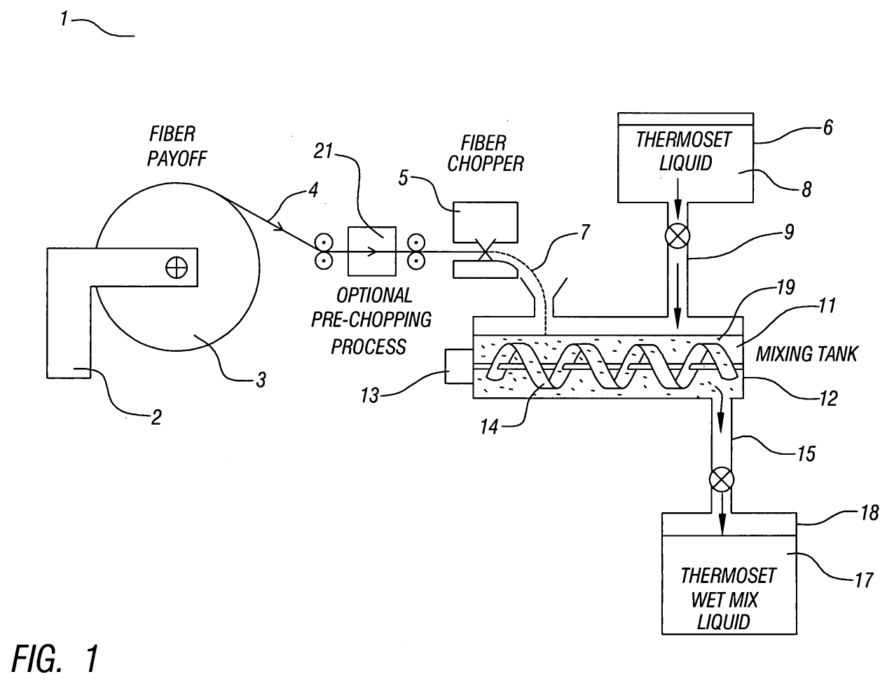

Referring now to FIG. 1, an embodiment of the present invention is illustrated. A method 1 of manufacturing a unique, thermosetting wet mix conductively doped resin-based material of the present invention is illustrated. In this method, a chord 4 of multiple fiber strands is chopped and is substantially homogeneously mixed into a thermosetting liquid material to form a thermoset wet mix liquid having excellent properties.

In the illustrated embodiment, a reel 3 of conductive fiber 4 is loaded onto a payoff apparatus 2. The conductive fiber 4 preferably comprises multiple, parallel strands of micron fiber. Each strand of micron conductive fiber 4 is preferably in the range of between about 6 and about 12 microns in diameter. This micron conductive fiber 4 preferably comprises a metal or a metal alloy. Alternatively, the fiber may comprise a non-metal material that has been metal coated. Further preferred embodiments of the micron conductive fiber are described below.

The micron conductive fiber bundle 4 is routed into the chopping, or cutting, apparatus 5. In some embodiments of the process, however, it is useful to pre-process the fiber bundle 4 prior to chopping. An optional pre-chopping process 21, or combination of processes, is performed to enhance the characteristics of the fibers 4 prior to chopping. Pretreatment processes include, but are not limited, chemical modification processes that improve the fibers interfacial properties.

There are several embodiments of inert chemical modification processes that improve the fibers interfacial properties. Treatments include, but are not limited to, chemically inert coupling agents, gas plasma, anodizing, mercerization, peroxide treatment, benzoylation, and other chemical or polymer treatments. A chemically inert coupling agent is a material that is bonded onto the surface of metal fiber to provide an excellent coupling surface for later bonding with the resin-based material. This chemically inert coupling agent does not react with the resin-based material. An exemplary chemically inert coupling agent is silane. In a silane treatment, silicon-based molecules from the silane molecularly bond to the surface of metal fibers to form a silicon layer. The silicon layer bonds well with the subsequently extruded resin-based material yet is chemically inert with respect to resin-based materials. As an optional feature during a silane treatment, oxane bonds with any water molecules on the fiber surface to thereby eliminate water from the fiber strands. Silane, amino, and silane-amino are three exemplary pre-extrusion treatments for forming chemically inert coupling agents on the fiber.

In a gas plasma treatment, the surfaces of the metal fibers are etched at atomic depths to re-engineer the surface. Cold temperature gas plasma sources, such as oxygen and ammonia, are useful for performing a surface etch prior to extrusion. In one embodiment of the present invention, gas plasma treatment is first performed to etch the surfaces of the fiber strands. A silane bath coating is then performed to form a chemically inert silicon-based film onto the fiber strands. In another embodiment, metal fiber is anodized to form a metal oxide over the fiber. The fiber modification processes described herein are useful for improving interfacial adhesion, improving wetting during homogenization, and/or reducing and preventing oxide growth (when compared to non-treated fiber). Pretreatment fiber modification may also reduce levels of dust, fines, and fiber release during subsequent cutting articles formed from the thermoset wet mix. After the optional pretreatment, the micron fiber bundle 4 is routed into the chopping process 5.

As another embodiment, the multiple strand fiber 4 is pulled from the payoff reel 3 and then routed into a chopping, or cutting, apparatus 5. In one embodiment, the chopping apparatus 5 comprises a cutting die. In this case the fiber 4 is indexed into the die, the die is pressed onto the 4, and fiber segments 7 are chopped from the fiber feed 4. In another embodiment, the chopping apparatus comprises a blade configuration that opens/closes on the fiber feed 4 as the feedstock passes through. In one embodiment, a single blade is used to cut each segment 7. In another embodiment, multiple blades are used either to cut multiple segments at once or to cut through a single segment with blades coming from multiple angles such as in a concentric blade shutter system. The fiber chopper 5 converts the incoming fiber feedstock 4 into a plurality of fiber segments 7 having equal, or nearly equal, lengths. The fiber segments 7 are preferably cut to lengths of between about 2 millimeters and about 14 millimeters although longer or shorter lengths may be used. The fiber segments 7 are then routed into the mixing tank 12.

As another embodiment, liquid thermoset 8 is also routed into the mixing tank 12. The liquid thermoset 8 comprises at least one resin-based compound capable of forming polymer chains. The resin-based compound may be in monomer or polymer form. In various embodiments, other chemicals, such as plasticizers, solvents, emulsifiers, stabilizers, pigments, or the like, are added to the resin-based compound to achieve the desired properties such as viscosity, stability, color, and the like. The thermosetting liquid 8 may be stored in an automated material handler 6 and 9, as shown, or may be added to the mixing tank 12 by hand. Importantly, the thermosetting liquid 8 is not in its final, set state. Whatever the catalyst of setting, whether heat, light, reactive chemical, additional monomer/polymer, and/or pressure, or the like, the setting catalyst is kept separate from the thermosetting liquid at this point.

In the mixing tank 12, the thermosetting liquid 8 and the chopped fiber 7 are combined and substantially homogeneously mixed to create the thermoset wet mix 11. In the illustrated embodiment, a bladed mixing apparatus 13 and 14 is used. During mixing, the chopped fiber strands 7 are dispersed in the thermoset liquid 8 such that individual strands 19 of fiber are released from the multiple strand fiber unit 7. The bladed mixing apparatus 13 and 14 is optimized to a speed sufficient to thoroughly combine the individual fiber strands 19 and the thermosetting liquid 8 into a homogenous mixture 11. The mixing speed, blade configuration, and mixing time are optimized to provide sufficient throughput of material while limiting breakage of the micron fiber strands 19 during the mixing process. After mixing, the completed thermosetting wet mix conductively doped resin-based material 17 is routed out of the mixing tank 12 and into a storage tank 18 or into a finished product container. While an automated mixing tank apparatus 12 and product routing 15 and storage apparatus 18 are shown, it is understood that non-automated apparatus can be used.

The present invention produces a novel, thermosetting wet mix liquid having a useful combination of features. First, the conductive fibers 19 are homogenously mixed into the thermosetting liquid 11. As a result, when the thermosetting wet mix liquid is applied, sprayed, coated, molded, or the like, and then sets, the conductive fibers form a conductive network within the polymer matrix. The resulting thermoset conductively doped resin-based material exhibits many novel and very useful properties such as excellent thermal and electrical conductivity and electromagnetic energy absorption. These properties are combined with the characteristics of the base thermoset material to create a truly unique material. For example, a material with conductivity comparable to, or greater than, pure copper can be formulated. Yet, this material can be lighter in weight and lower in cost than copper. Further, in one embodiment, a non-corrosive conductive fiber is used such that a highly conductive, non-corrosive material is derived.

The thermosetting wet mix material is versatile. Because the thermoset wet mix 17 is a liquid, it can be applied to another article via a sprayer. For example, a layer of the thermoset conductively doped resin-based material may be spray coated onto a metal structure to increase electromagnetic energy absorption while decreasing reflection. If a hardening agent must be used to catalyze the thermosetting reaction, then this is added at the time of spraying. The hardened thermoset conductively doped resin-based material creates a highly conductive and electromagnetic energy absorbing layer over the metal structure. Incident electromagnetic energy is absorbed by the conductively doped resin-based material rather than being reflected by the metal structure. This approach is useful for reducing electromagnetic interference as well as reducing the radar profile of structures.

In another embodiment, the thermosetting wet mix material 17 is simply applied by dip-coating an article into a tank of the thermosetting wet mix material 17. In another embodiment, the thermosetting wet mix material is formed or applied as a foam. In another embodiment, the thermosetting wet mix liquid material is injected into a mold. A catalyst, such as heat and/or pressure, is then used to cause the setting reaction to harden the conductively doped resin-based material. In another embodiment, the thermosetting wet mix liquid comprises a monomer base resin. During the molding process, a second monomer material is co-injected into the mold with the thermosetting wet mix liquid. The first and second monomers react to form cross-linked polymers and to harden the conductively doped resin-based material into the molded shape. In another embodiment, the thermosetting wet mix liquid material is forced into a pultrusion die along with the catalyzing agent, such as a chemical, heat, or the like. A wire or other strand material is then pulled through the pultrusion die and a layer of the thermoset conductively doped resin-based material is thus formed around the wire of strand.

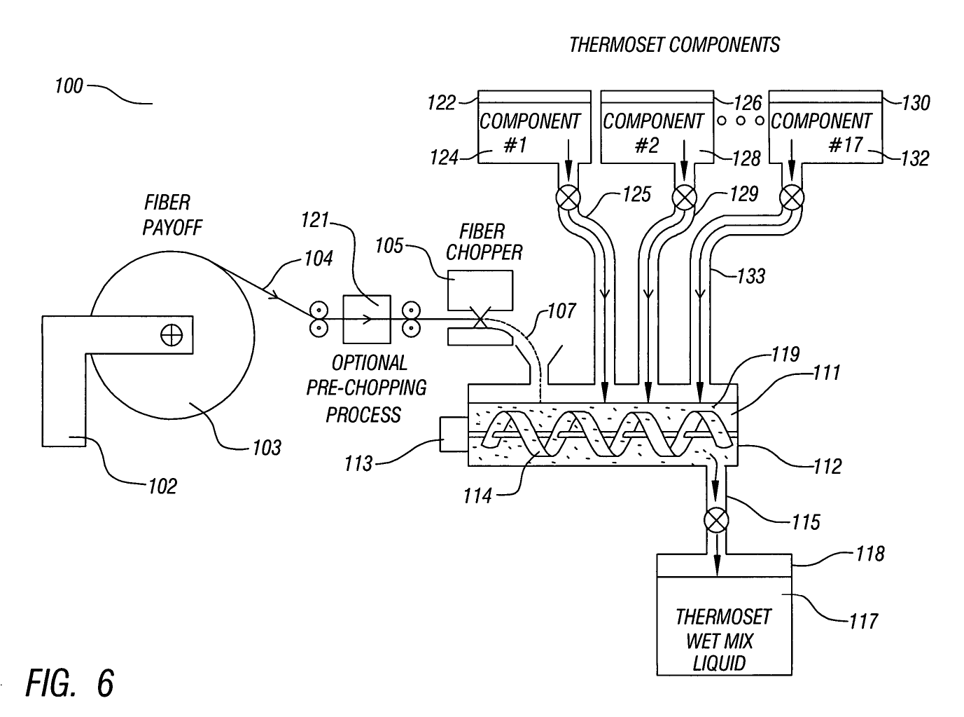

Referring now to FIG. 6, another embodiment of the present invention is illustrated. Another method 100 of manufacturing a unique, thermosetting wet mix conductively doped resin-based material of the present invention is illustrated. In this method 100, a chord 104 of multiple fiber strands is chopped and is substantially homogeneously mixed into a thermosetting liquid material to form a thermoset wet mix liquid having excellent properties. In this case, the mixing apparatus 112 is further used to provide substantially homogeneous mixing of the thermosetting liquid components 124, 128, and 132.

In the illustrated embodiment, a reel 103 of conductive fiber 104 is loaded onto a payoff apparatus 102. The conductive fiber 104 preferably comprises multiple, parallel strands of micron fiber. Each strand of micron conductive fiber 104 is preferably in the range of between about 6 and about 12 microns in diameter. This micron conductive fiber 104 preferably comprises a metal or a metal alloy. Alternatively, the fiber may comprise a non-metal material that has been metal coated. Further preferred embodiments of the micron conductive fiber are described below.

The micron conductive fiber 104 is routed into the chopping, or cutting, apparatus 105. In some embodiments of the process, however, it is useful to pre-process the fiber bundle 104 prior to chopping. An optional pre-chopping process 121, or combination of processes, is performed to enhance the characteristics of the fibers 104 prior to chopping. Pretreatment processes include, but are not limited, chemical modification processes that improve the fibers interfacial properties.

There are several embodiments of inert chemical modification processes that improve the fibers interfacial properties. Treatments include, but are not limited to, chemically inert coupling agents, gas plasma, anodizing, mercerization, peroxide treatment, benzoylation, and other chemical or polymer treatments. A chemically inert coupling agent is a material that is bonded onto the surface of metal fiber to provide an excellent coupling surface for later bonding with the resin-based material. This chemically inert coupling agent does not react with the resin-based material. An exemplary chemically inert coupling agent is silane. In a silane treatment, silicon-based molecules from the silane molecularly bond to the surface of metal fibers to form a silicon layer. The silicon layer bonds well with the subsequently extruded resin-based material yet is chemically inert with respect to resin-based materials. As an optional feature during a silane treatment, oxane bonds with any water molecules on the fiber surface to thereby eliminate water from the fiber strands. Silane, amino, and silane-amino are three exemplary pre-extrusion treatments for forming chemically inert coupling agents on the fiber.

In a gas plasma treatment, the surfaces of the metal fibers are etched at atomic depths to re-engineer the surface. Cold temperature gas plasma sources, such as oxygen and ammonia, are useful for performing a surface etch prior to extrusion. In one embodiment of the present invention, gas plasma treatment is first performed to etch the surfaces of the fiber strands. A silane bath coating is then performed to form a chemically inert silicon-based film onto the fiber strands. In another embodiment, metal fiber is anodized to form a metal oxide over the fiber. The fiber modification processes described herein are useful for improving interfacial adhesion, improving wetting during homogenization, and/or reducing and preventing oxide growth (when compared to non-treated fiber). Pretreatment fiber modification may also reduce levels of dust, fines, and fiber release during subsequent cutting articles formed from the thermoset wet mix. After the optional pretreatment, the micron fiber bundle 104 is routed into the chopping process 105.

The multiple strand fiber 104 is pulled from the payoff reel 103 and then routed into a chopping, or cutting, apparatus 105. In one embodiment, the chopping apparatus 105 comprises a cutting die. In this case the fiber 104 is indexed into the die, the die is pressed onto the fiber 104, and fiber segments 107 are chopped from the fiber feed 104. In another embodiment, the chopping apparatus comprises a blade configuration that opens/closes on the fiber feed 104 as the feedstock passes through. In one embodiment, a single blade is used to cut each segment 107. In another embodiment, multiple blades are used either to cut multiple segments at once or to cut through a single segment with blades coming from multiple angles such as in a concentric blade shutter system. The fiber chopper 105 converts the incoming fiber feedstock 104 into a plurality of fiber segments 107 having equal, or nearly equal, lengths. The fiber segments are cut to lengths of between about 2 millimeters and about 14 millimeters although longer or shorter lengths may be used. The fiber segments 107 are then routed into the mixing tank 112.

Components of the thermosetting liquid 124, 128, and 132 are also routed into the mixing tank 112. The liquid thermoset 111 and 117 comprises at least one resin-based compound capable of forming polymer chains. The resin-based compound may be in monomer or polymer form. In this embodiment, any or all of the various components of the final thermosetting liquid are individually routed to the mixing tank 111. The components 124, 128, and 132 comprise, for example, resin-based monomer and/or polymer, plasticizing agents that lower the glass transition temperature of the resin-based material, solvents, emulsifiers, stabilizers, pigments, or the like. These several components 124, 128, and 132, may be routed to the mixing tank 112 via holding tanks 122, 126, and 130, and plumbing 125, 129, and 133, or may be added to the mixing tank 112 manually. The combination of the components 124, 128, and 132 produces the thermosetting liquid 111 and 117 having the required properties such as viscosity, stability, color, and the like. While three components 124, 128, and 132 are shown in the illustration, it is understood that any number of components could be added into the mixing tank 112 in this way. Further, the components 124, 128, and 132 may be in liquid or solid form.

In the mixing tank 112, the thermosetting liquid components 124, 128, and 132 and the chopped fiber 107 are combined and substantially homogeneously mixed to create the thermoset wet mix 111. In the illustrated embodiment, a bladed mixing apparatus 113 and 114 is used. During mixing, the chopped fiber strands 107 are dispersed in the thermoset liquid 108 such that individual strands 119 of fiber are released from the multiple strand fiber unit 107. The bladed mixing apparatus 113 and 114 is optimized to a speed sufficient to thoroughly combine the thermosetting components 124, 128, and 132 and the individual fiber strands 119 into a homogenous mixture 111. The mixing speed, blade configuration, and mixing time are optimized to provide sufficient throughput of material while limiting breakage of the micron fiber strands 119 during the mixing process. After mixing, the completed thermosetting wet mix conductively doped resin-based material 117 is routed out of the mixing tank 112 and into a storage tank 118 or into a finished product container. While an automated mixing tank apparatus 112 and product routing 115 and storage apparatus 118 are shown, it is understood that non-automated apparatus can be used. Importantly, the thermoset wet mix 117 is not in its final, set state. Whatever the catalyst of setting, whether heat, light, reactive chemical, additional monomer/polymer, and/or pressure, or the like, the setting catalyst is kept separate from the thermosetting wet mix 117 at this point.

The resin-based material is carefully combined such that the percent, by weight, of the micron conductive fiber 118 in the thermoset wet mix material 117 is carefully controlled. More particularly, in one embodiment, the micron conductive fiber 119 comprises between about 10% and about 90% of the total weight of the thermoset wet mix 111 and 117. In a more preferred embodiment, the micron conductive fiber comprises between about 20% and about 80% of the total weight of the thermoset wet mix.

As an additional embodiment of the present invention, micron conductive powder is added into the mixing tank 112. As a result, the thermoset conductively doped resin-based material contains both micron conductive powder and the micron conductive fiber. This process method is also designed and carefully controlled to produce a resulting thermoset wet mix having a percent, by weight, of the combined micron conductive fiber and the micron conductive powder within the specified range of the present invention. In one embodiment, the combined micron conductive fiber and micron conductive powder comprises between about 10% and about 90% of the total weight of the thermoset wet mix. In a more preferred embodiment, the combined micron conductive fiber and micron conductive powder comprises between about 20% and about 80% of the total weight of the thermoset wet mix.

Further, the novel formulation thermoset wet mix of the present invention further provides an optimal concentration of conductive doping to achieve high electrical conductivity and exceptional performance characteristics within the EMF or electronics spectrum(s) for many applications including antenna applications and/or EMI/RFI absorption applications. The novel formulation also results in excellent thermal conductivity, acoustical performance, and mechanical performance of molded articles. The novel formulation creates a conductively doped composition and a doping concentration that creates an exceptional conductive network in the molded article. The novel formulation insures that the resulting molded article achieves sufficient conductive doping from the wet mix, alone, to exhibit excellent electrical, thermal, acoustical, mechanical, and electromagnetic properties from a well-formed conductive network within the resin-based polymer matrix.

Further, the novel formulation of the present invention creates a thermoset wet mix provides a substantially homogeneously mixed material without damaging the fiber doping. Problems of non-homogenous mixing, fiber damage, fiber clumping, ganging, balling, swirling, hot spots and mechanical failures are eliminated.

Further, the novel formulation of the thermoset wet mix of the present invention is very well suited for use with micron conductive fibers. The orientation of the micron conductive fibers, such as random, omni-directional, or parallel, in the molded conductively doped resin-based article can significantly affect the performance of the article. As is known in the art, mold design, gating, protrusion designs, or other means within the molding apparatus, may be used to control the orientation of dopant materials incorporated into a resin-based material. The thermoset wet mix of the present invention is particularly useful in facilitating the ability to control fiber directionality due to the ease with which initial homogenization occurs without over-mixing.

Further, the novel formulation of the thermoset wet mix of the present invention provides a homogeneously mixed composite material of conductive elements and base resin that is optimized to maximize molecular interaction between the base resin polymer and the conductive elements. Equalization and intertwining of the network of conductive elements with the base resin molecular chains results in enhanced molecular properties in the base resin polymer chain including physical, electrical, and other desirable properties.

The conductive fiber of the present invention creates a high aspect ratio conductive element such that individual fiber elements easily overlap with each other. As a result, the conductive lattice exhibits electron exchange capability on par with low resistance, pure metals such as copper. By comparison, conductive powders present essentially no aspect ratio for overlapping. Therefore, a very high conductive powder doping must be used to generate a low resistance molded material. However, this doping must be so large that it disrupts the resin polymer chain structures and results in a molded part with very poor structural performance. Conductive flakes present a better aspect ratio than powders but still do not provide the combined low resistance and sound structural performance found in the present invention.

The conductive loading of the thermoset wet mix comprises conductive fiber and/or conductive powder. In one embodiment of the present invention, this conductive fiber and/or conductive powder comprise metal material. More particular to the present invention, this metal material is preferably in any form of, but not limited to, pure metal, combinations of metals, metal alloys, metals clad onto other metals, and the like. More particular to the present invention, this metal material is combined with the resin based material using a wet mixing method as illustrated herein in FIGS. 1 and 6. As is described in these embodiments, the conductive loading preferably begins as a bundle of very fine wire called a micron fiber bundle. This micron fiber bundle is then cut to form fiber segments that are mixed with liquid resin-based material.

There are numerous metal materials that can be used to form the micron fiber bundle according to the present invention. An exemplary list of micron wire materials includes:
(1) copper, alloys of copper such as coppered alloyed with any combination of beryllium, cobalt, zinc, lead, silicon, cadmium, nickel, iron, tin, chromium, phosphorous, and/or zirconium, and copper clad in another metal such as nickel;
(2) aluminum and alloys of aluminum such as aluminum alloyed with any combination of copper, magnesium, manganese, silicon, and/or chromium;
(3) nickel and alloys of nickel including nickel alloyed with any combination of aluminum, titanium, iron, manganese, and/or copper;
(4) precious metals and alloys of precious metals including gold, palladium, platinum, platinum, iridium, rhodium, and/or silver;
(5) glass ceiling alloys such as alloys of iron and nickel, iron and nickel alloy cores with copper cladding, and alloys of nickel, cobalt, and iron;
(6) refractory metals and alloys of refractory metals such as molybdenum, tantalum, titanium, and/or tungsten;
(7) resistive alloys comprising any combination of copper, manganese, nickel, iron, chromium, aluminum, and/or iron;
(8) specialized alloys comprising any of combination of nickel, iron, chromium, titanium, silicon, copper clad steel, zinc, and/or zirconium;
(9) spring wire formulations comprising alloys of any combination of cobalt, chromium, nickel, molybdenum, iron, niobium, tantalum, titanium, and/or manganese;
(10) stainless steel comprising alloys of iron and any combination of nickel, chromium, manganese, and/or silicon;
(11) thermocouple wire formulations comprising alloys of any combination of nickel, aluminum, manganese, chromium, copper, and/or iron

Within this preferred embodiment wherein the conductive loading material comprises a micron fiber bundle, it is common to specify this type of material in terms of feet per pound. It is relatively straightforward to convert the desired percent by weight, of the conductive loading into the feet per pound regime.

The several embodiments of the thermoset wet mix conductively doped resin-based material according to the present invention are easily molded into manufactured articles by injection molding, extrusion molding, compression molding, and the like. The resulting molded articles comprise an optimal, conductively doped resin-based material. This conductively doped resin-based material typically comprises a micron powder(s) of conductor particles and/or in combination of micron fiber(s) substantially homogenized within a base resin host.

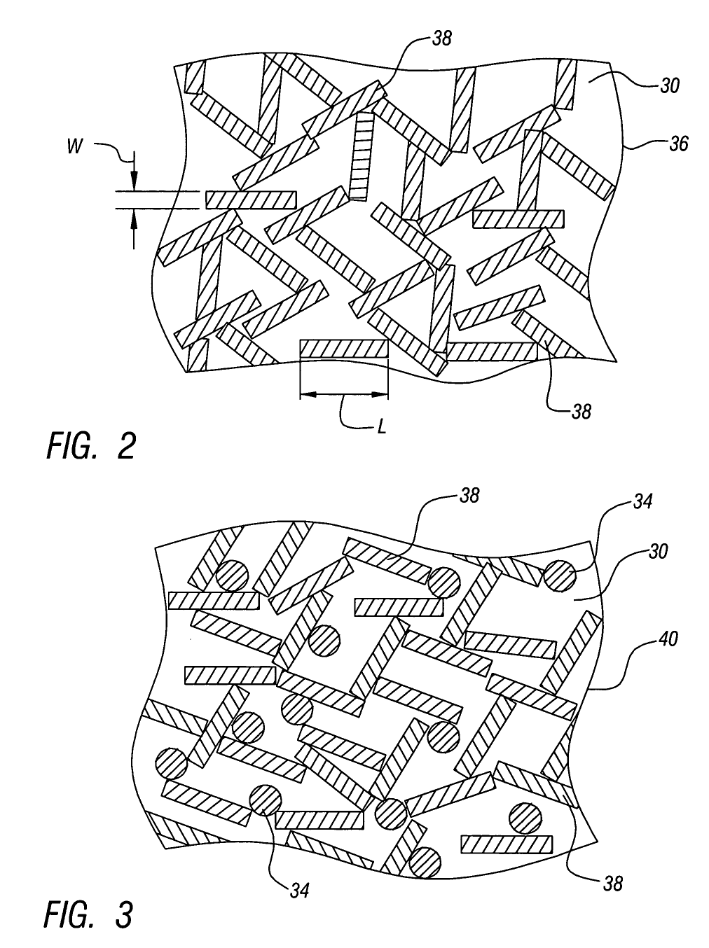

FIG. 2 shows a cross section view of an example of conductively doped resin-based material 36 having conductor fibers 38 in a base resin host 30. The conductor fibers 38 have a diameter of between about 3 and 12 microns, typically in the range of 10 microns or between about 8 and 12 microns, and a length of between about 2 and 14 millimeters. The micron conductive fibers 38 may be metal fiber or metal plated fiber. Further, the metal plated fiber may be formed by plating metal onto a metal fiber or by plating metal onto a non-metal fiber. Exemplary metal fibers include, but are not limited to, stainless steel fiber, copper fiber, nickel fiber, silver fiber, aluminum fiber, nichrome fiber, or the like, or combinations thereof. Exemplary metal plating materials include, but are not limited to, copper, nickel, cobalt, silver, gold, palladium, platinum, ruthenium, rhodium, and nichrome, and alloys of thereof. Any platable fiber may be used as the core for a non-metal fiber. Exemplary non-metal fibers include, but are not limited to, carbon, graphite, polyester, basalt, man-made and naturally-occurring materials, and the like. In addition, superconductor metals, such as titanium, nickel, niobium, and zirconium, and alloys of titanium, nickel, niobium, and zirconium may also be used as micron conductive fibers and/or as metal plating onto fibers in the present invention.

These conductor particles and/or fibers are substantially homogenized within a base resin. As previously mentioned, the conductively doped resin-based materials have a sheet resistance of less than about 5 to more than about 25 ohms per square, though other values can be achieved by varying the doping parameters and/or resin selection. To realize this sheet resistance the weight of the conductor material comprises between about 20% and about 50% of the total weight of the conductively doped resin-based material. More preferably, the weight of the conductive material comprises between about 20% and about 40% of the total weight of the conductively doped resin-based material. More preferably yet, the weight of the conductive material comprises between about 25% and about 35% of the total weight of the conductively doped resin-based material. Still more preferably yet, the weight of the conductive material comprises about 30% of the total weight of the conductively doped resin-based material. Stainless Steel Fiber of 6-12 micron in diameter and lengths of 4-6 mm and comprising, by weight, about 30% of the total weight of the conductively doped resin-based material will produce a very highly conductive parameter, efficient within any EMF, thermal, acoustic, or electronic spectrum.

In yet another preferred embodiment of the present invention, the conductive doping is determined using a volume percentage. In a most preferred embodiment, the conductive doping comprises a volume of between about 4% and about 10% of the total volume of the conductively doped resin-based material. In a less preferred embodiment, the conductive doping comprises a volume of between about 1% and about 50% of the total volume of the conductively doped resin-based material though the properties of the base resin may be impacted by high percent volume doping.

Referring now to FIG. 3, another preferred embodiment of the present invention is illustrated where the conductive materials comprise a combination of both conductive powders 34 and micron conductive fibers 38 substantially homogenized together within the resin base 30 during a molding process.

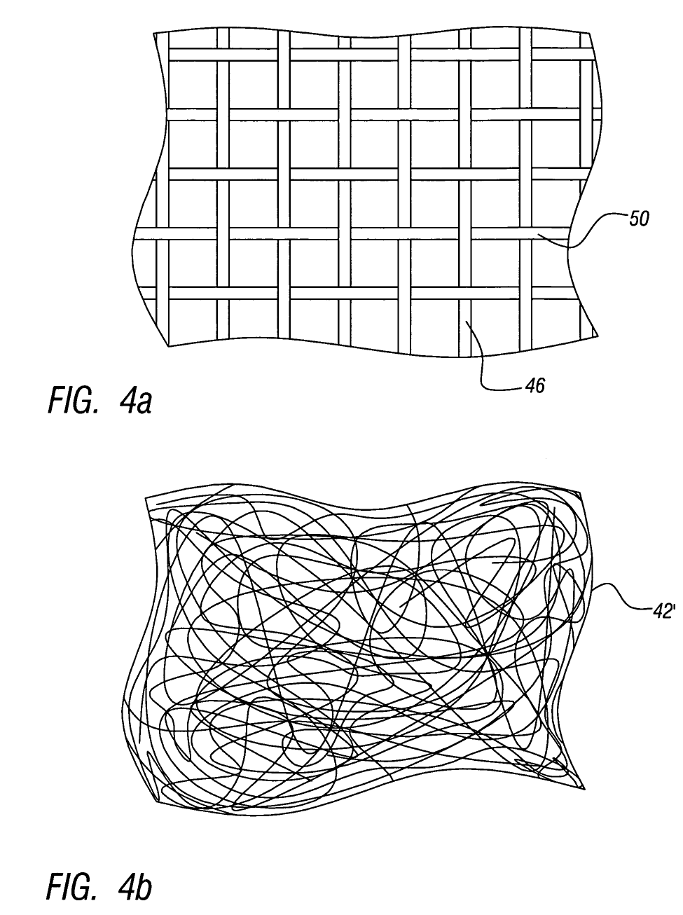

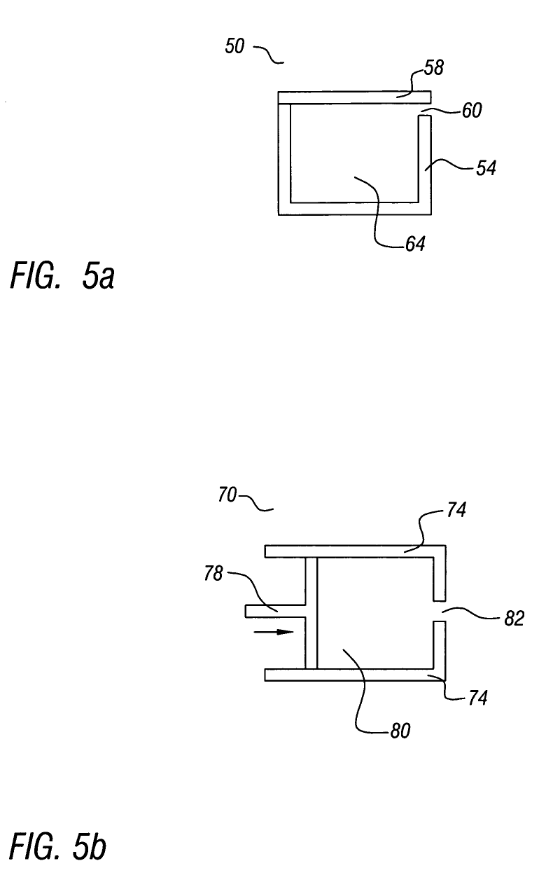

Referring now to FIGS. 4a and 4b, a preferred composition of the conductively doped, resin-based material is illustrated. The conductively doped resin-based material can be formed into fibers or textiles that are then woven or webbed into a conductive fabric. The conductively doped resin-based material is formed in strands that can be woven as shown. FIG. 4a shows a conductive fabric 42 where the fibers are woven together in a two-dimensional weave 46 and 50 of fibers or textiles. FIG. 4b shows a conductive fabric 42′ where the fibers are formed in a webbed arrangement. In the webbed arrangement, one or more continuous strands of the conductive fiber are nested in a random fashion. The resulting conductive fabrics or textiles 42, see FIG. 5a, and 42′, see FIG. 5b, can be made very thin, thick, rigid, flexible or in solid form(s).

Similarly, a conductive, but cloth-like, material can be formed using woven or webbed micron stainless steel fibers, or other micron conductive fibers. These woven or webbed conductive cloths could also be sandwich laminated to one or more layers of materials such as Polyester(s), Teflon(s), Kevlar(s) or any other desired resin-based material(s). This conductive fabric may then be cut into desired shapes and sizes.

Articles formed from conductively doped resin-based materials can be formed or molded in a number of different ways including injection molding, extrusion, calendaring, compression molding, thermoset molding, or chemically induced molding or forming. FIG. 5a shows a simplified schematic diagram of an injection mold showing a lower portion 54 and upper portion 58 of the mold 50. Conductively doped resin-based material is injected into the mold cavity 64 through an injection opening 60 and then the substantially homogenized conductive material cures by thermal reaction. The upper portion 58 and lower portion 54 of the mold are then separated or parted and the articles are removed.

FIG. 5b shows a simplified schematic diagram of an extruder 70 for forming articles using extrusion. Conductively doped resin-based material(s) is placed in the hopper 80 of the extrusion unit 74. A piston, screw, press or other means 78 is then used to force thermally molten, chemically-induced compression, or thermoset curing conductively doped resin-based material through an extrusion opening 82 which shapes the thermally molten curing or chemically induced cured conductively doped resin-based material to the desired shape. The conductively doped resin-based material is then fully cured by chemical reaction or thermal reaction to a hardened or pliable state and is ready for use. Thermoplastic or thermosetting resin-based materials and associated processes may be used in molding the conductively doped resin-based articles of the present invention.

The advantages of the present invention may now be summarized. An effective wet mix thermoset material useful for spraying and/or molding conductively doped resin-based articles is described. A method to generate an effective wet mix thermoset material useful for spraying and/or molding conductively doped resin-based articles is described. A method to form articles from a thermoset wet mix, conductively doped resin-based material is described.

While the invention has been particularly shown and described with reference to the preferred embodiments thereof, it will be understood by those skilled in the art that various changes in form and details may be made without departing from the scope of the invention.

What is claimed is:

1. A method to generate a thermoset wet mix material comprising:
providing a thermosetting resin-based material;
chopping a bundle of micron conductive fiber strands;
adding said chopped micron conductive fiber to said thermosetting resin-based material; and
substantially homogeneously mixing said chopped fiber strands and said thermosetting resin-based material to form a thermoset wet mix material.

2. The method according to claim 1 further comprising pre-treating said bundle prior to said step of chopping.

3. The method according to claim 2 wherein said step of pre-treating comprises forming a chemically inert coupling agent onto said micron conductive fiber strands.

4. The method according to claim 2 wherein said step of pre-treating comprises anodizing said micron conductive fiber.

5. The method according to claim 2 wherein said step of pre-treating comprises exposing said micron conductive fiber strands to gas plasma.

6. The method according to claim 1 further comprising the step of adding a micron conductive material to said thermosetting resin-based material prior to said step of substantially homogeneously mixing.

7. The method according to claim 1 wherein said step of providing a thermosetting resin-based material comprises combining two or more chemical components into the same tank used for said step of substantially homogeneously mixing.

8. The method according to claim 7 wherein said chemical components are any of resin-based monomer, resin-based polymer, plasticizing agent, solvent, emulsifier, stabilizer, and pigment.

9. The method according to claim 1 wherein said micron conductive fiber comprises between about 10% and about 90% of the total weight of said thermoset wet mix material.

10. The method according to claim 1 wherein said micron conductive fiber comprises between about 20% and about 50% of the total weight of said thermoset wet mix material.

11. The method according to claim 1 wherein said micron conductive fiber comprises between about 1% and about 50% of the total volume of said thermoset wet mix material.

12. The method according to claim 1 wherein said micron conductive fiber comprises between about 4% and about 10% of the total volume of said thermoset wet mix material.

13. The method according to claim 1 wherein said micron conductive fiber comprises a metal or alloy of metal.

14. The method according to claim 1 wherein said micron conductive fiber comprises a non-conductive inner core material with outer metal plating or metal alloy plating.

15. The method according to claim 1 wherein said micron conductive fiber comprises a ferromagnetic material.

16. The method according to claim 1 wherein said chopped micron conductive fiber has a length of between about 2 millimeters and about 14 millimeters.

17. A method to generate a thermoset wet mix material comprising:
providing a thermosetting resin-based material;
forming a chemically inert coupling agent onto micron conductive fiber strands;
thereafter chopping said micron fiber strands;
adding said chopped micron conductive fiber to said thermosetting resin-based material; and
substantially homogeneously mixing said chopped fiber strands and said thermosetting resin-based material to form a thermoset wet mix material.

18. The method according to claim 17 further comprising the step of adding a micron conductive material to said thermosetting resin-based material prior to said step of substantially homogeneously mixing.

19. The method according to claim 17 wherein said step of providing a thermosetting resin-based material comprises combining two or more chemical components into the same tank used for said step of substantially homogeneously mixing.

20. The method according to claim 19 wherein said chemical components are any of resin-based monomer, resin-based polymer, plasticizing agent, solvent, emulsifier, stabilizer, and pigment.

21. The method according to claim 17 wherein said micron conductive fiber comprises between about 10% and about 90% of the total weight of said thermoset wet mix material.

22. The method according to claim 17 wherein said micron conductive fiber comprises between about 20% and about 50% of the total weight of said thermoset wet mix material.

23. The method according to claim 17 wherein said micron conductive fiber comprises between about 1% and about 50% of the total volume of said thermoset wet mix material.

24. The method according to claim 17 wherein said micron conductive fiber comprises between about 4% and about 10% of the total volume of said thermoset wet mix material.

25. The method according to claim 17 wherein said micron conductive fiber comprises a metal or alloy of metal.

26. The method according to claim 17 wherein said micron conductive fiber comprises a non-conductive inner core material with outer metal plating or metal alloy plating.

27. The method according to claim 17 wherein said micron conductive fiber comprises a ferromagnetic material.

28. The method according to claim 17 wherein said chopped micron conductive fiber has a length of between about 2 millimeters and about 14 millimeters.

29. A method to form an article comprising:
providing a thermoset wet mix material comprising a thermosetting resin-based material substantially homogeneously mixed with micron chopped fiber;
placing said thermoset wet mix material into contact with a structure; and
setting said placed thermoset wet mix to complete said article.

30. The method according to claim 29 wherein said step of placing said thermoset wet mix material is by injecting or by flowing and wherein said structure is a die.

31. The method according to claim 29 wherein said step of placing said thermoset wet mix material is by spraying or by coating said structure with said thermoset wet mix material.

32. The method according to claim 29 wherein said step of placing said thermoset wet mix material is by dipping said structure into said thermoset wet mix material.

33. The method according to claim 29 wherein said thermoset wet mix material is a foam.

34. The method according to claim 29 wherein said micron conductive fiber comprises between about 20% and about 50% of the total weight of said thermoset wet mix material.

35. The method according to claim 29 wherein said micron conductive fiber comprises between about 4% and about 10% of the total volume of said thermoset wet mix material.

36. The method according to claim 29 wherein said micron conductive fiber comprises a metal or alloy of metal.

37. The method according to claim 29 wherein said micron conductive fiber comprises a non-conductive inner core material with outer metal plating or metal alloy plating.

38. The method according to claim 29 wherein said step of setting comprises exposing said thermoset wet mix to heat, light, reactive chemical, additional monomer, additional polymer, or pressure.
